(19) United States
(12) Patent Application Publication
(10) Pub. No.: US 2025/0277589 A1
(43) Pub. Date: Sep. 4, 2025

(54) COOKING METHOD AND APPARATUS, DEVICE, AND STORAGE MEDIUM

(71) Applicant: JIU TAI GROUP CO., LTD., Hong Kong (CN)

(72) Inventors: Qing WANG, Hong Kong (CN); Lianwei YANG, Hong Kong (CN); Robert NEWTON, Hong Kong (CN)

(21) Appl. No.: 19/186,683

(22) Filed: Apr. 23, 2025

Related U.S. Application Data
(63) Continuation of application No. PCT/CN2022/127474, filed on Oct. 25, 2022.

(51) Int. Cl. F24C 7/08; F24C 7/02; H05B 6/64; H05B 6/68

(52) U.S. Cl. CPC F24C 7/087; F24C 7/02; H05B 6/645; H05B 6/687; H05B 6/688

(57) ABSTRACT

Provided are a cooking method and apparatus, a device, and a storage medium. The method includes: controlling, by a control panel based on a control instruction, a radiator to radiate a first operation electromagnetic wave to multiple heating positions in an interior of a heating cavity, to obtain multiple intermediate state ingredients; generating, by the control panel, multiple regulation instructions based on heating state information on the multiple intermediate state ingredients; adjusting, by the control panel, the first operation electromagnetic wave based on the multiple regulation instructions, to obtain a second operation electromagnetic wave; adjusting, by the control panel, an initial operation mode based on the multiple regulation instructions to obtain a regulation operation mode; and radiating, by the radiator in the regulation operation mode, the second operation electromagnetic wave to the multiple heating positions in the interior of the heating cavity.

This application is a continuation of International Patent Application No. PCT/CN2022/127474, filed on Oct. 25, 2022, which is incorporated herein by reference in its entirety.

### FIELD

The present disclosure belongs to the field of cooking technologies, and more particularly, to a cooking method and apparatus, a device, and a storage medium.

### BACKGROUND

A microwave oven is a common cooking appliance in the home kitchen today and is popular among users for its high heating efficiency, cost effectiveness, and ease of operation. An operating principle of the microwave oven is to heat food from inside to outside thereof to cook the food by means of a characteristic of food generating heating by its own through absorbing electromagnetic waves emitted by a magnetron.

### SUMMARY

The present disclosure aims to solve at least one of the technical problems in the related art to some extent. To this end, an object of the present disclosure is to provide a cooking method and apparatus, a device, and a storage medium, which enables each ingredient to be heated to be heated to respective target temperatures and to be taken out simultaneously.

In order to solve the above technical problems, embodiments of the present disclosure provide the following technical solutions.

In a first aspect, according to an embodiment of the present disclosure, a cooking method is provided. The cooking method includes: obtaining, by a control panel, state information on a plurality of ingredients to be heated, and generating a control instruction based on the state information, the state information including a first temperature and a cooking attribute of each of the plurality of ingredients to be heated; controlling, by the control panel based on the control instruction, a radiator, to radiate, in an initial operation mode, a first operation electromagnetic wave to a plurality of heating positions in an interior of a heating cavity, to heat each of the plurality of ingredients to be heated from the first temperature to a second temperature with the first operation electromagnetic wave, to obtain a plurality of intermediate state ingredients, a parameter of the initial operation mode including a rotation speed and a radiation direction of the radiator; generating, by the control panel, a plurality of regulation instructions based on heating state information on the plurality of intermediate state ingredients; adjusting, by the control panel, the first operation electromagnetic wave based on the plurality of regulation instructions, to obtain a second operation electromagnetic wave; adjusting, by the control panel, the initial operation mode based on the plurality of regulation instructions, to obtain a regulation operation mode; and radiating, by the radiator in the regulation operation mode, the second operation electromagnetic wave to the plurality of heating positions in the interior of the heating cavity, to heat each of the plurality of intermediate state ingredients from the second temperature to a target temperature with the second operation electromagnetic wave.

In a second aspect, according to an embodiment of the present disclosure, a cooking apparatus is provided. The apparatus includes: an obtaining module configured to obtain, by a control panel, state information on a plurality of ingredients to be heated, and generate a control instruction based on the state information, he state information including a first temperature and a cooking attribute of each of the plurality of ingredients to be heated; a first heating module configured to control, by the control panel based on the control instruction, a radiator to radiate, in an initial operation mode, a first operation electromagnetic wave to a plurality of heating positions in an interior of a heating cavity, to heat each of the plurality of ingredients to be heated from the first temperature to a second temperature with the first operation electromagnetic wave, to obtain a plurality of intermediate state ingredients, a parameter of the initial operation mode including a rotation speed and a radiation direction of the radiator; a generation module configured to generate, by the control panel, a plurality of regulation instructions based on heating state information on the plurality of intermediate state ingredients; a regulation module configured to adjust, by the control panel, the first operation electromagnetic wave based on the plurality of regulation instructions, to obtain a second operation electromagnetic wave, and adjust, by the control panel, the initial operation mode based on the plurality of regulation instructions, to obtain a regulation operation mode; and a second heating module configured to radiate, by the radiator in the regulation operation mode, the second operation electromagnetic wave to the plurality of heating positions in the interior of the heating cavity, to heat each of the plurality of intermediate state ingredients from the second temperature to a target temperature with the second operation electromagnetic wave.

In a third aspect, according to an embodiment of the present disclosure, a cooking device is provided. The cooking device includes: a heating cavity configured to accommodate a plurality of ingredients to be heated; a control panel configured to obtain state information on the plurality of ingredients to be heated, and generate a control instruction based on the plurality of ingredients to be heated, the state information including a first temperature and a cooking attribute of each of the plurality of ingredients to be heated; a magnetron connected to the heating cavity and in a communication connection with the control panel, the magnetron being configured to obtain operation power based on the control instruction, and emit an operation electromagnetic wave to an interior of the heating cavity based on the operation power; and a radiator disposed at a top of an inner side of the heating cavity and in a communication connection with the control panel, the radiator being configured to determine a rotation speed and a radiation direction based on the control instruction, and radiate the operation electromagnetic wave to a plurality of heating positions in the interior of the heating cavity based on the rotation speed and the radiation direction, and the operation electromagnetic wave at the plurality of heating positions being configured to heat each of the plurality of ingredients to be heated to a target temperature.

In a fourth aspect, according to an embodiment of the present disclosure, a computer-readable storage medium is provided. The computer-readable storage medium has a computer program stored thereon. The computer program, when executed, controls an apparatus provided with the computer-readable storage medium to perform the method described above.

Embodiments of the present disclosure can provide the following technical effects.

According to the above technical solutions of the present disclosure, 1) the control panel can scan, by a scanning unit, a Quick Response (QR) code on an outer package of each ingredient to be heated to obtain the cooking attribute of each ingredient to be heated. Such an operation is simple and quick.

2) During the heating of the plurality of ingredients to be heated, the operation electromagnetic wave of the magnetron and the radiation direction of the radiator can be determined based on the cooking attribute, the first temperature, and the cooking parameter of each ingredient to be heated, to heat each ingredient to be heated to its corresponding target temperature. In addition, after all the ingredients to be heated have reached respective target temperatures, the heated ingredients can be taken out simultaneously, which not only satisfies a user's need to heat the plurality of ingredients to be heated simultaneously, but also ensures the taste of each ingredient to be heated.

3) Each ingredient to be heated can be heated to the respective target temperature based on its corresponding cooking parameter, without reheating or taking in and out ingredients several times, which solves a problem of overheating or undercooking of the ingredients when heating the plurality of ingredients to be heated simultaneously.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

FIG. 1 is a schematic perspective structural view showing a cooking device according to an embodiment of the present disclosure.

FIG. 2 is a schematic structural view showing a cooking device according to an embodiment of the present disclosure.

FIG. 3 is a schematic flowchart showing a cooking method according to an embodiment of the present disclosure.

FIG. 4 is an example of a schematic flowchart showing a cooking method according to an embodiment of the present disclosure.

FIG. 5 is another example of a schematic flowchart showing a cooking method according to an embodiment of the present disclosure.

FIG. 6 is a schematic structural view showing a cooking apparatus according to an embodiment of the present disclosure.

### DESCRIPTION OF EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are merely illustrative, and are intended to explain, rather than limiting, the present disclosure.

To facilitate understanding of the embodiments by those skilled in the art, some of the terms are explained.
(1) WIFI: Wireless-Fidelity.
(2) BT: BitTorrent.
(3) 4G: 4th Generation.
(4) UHF: Ultra High Frequency.
(5) Zigbee: wireless sensor network technology.
(6) MIC: microphone.
(7) NFC: Near Field Communication.
(8) UART: Universal Asynchronous Receiver/Transmitter.
(9) USB: Universal Serial Bus.
(10) 485 in 485 interface: an interface standard for serial interfaces.

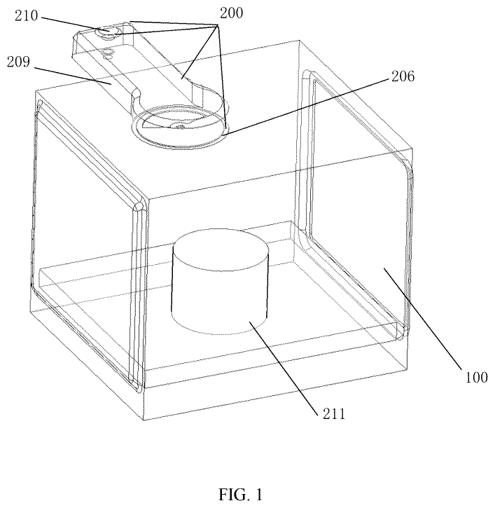

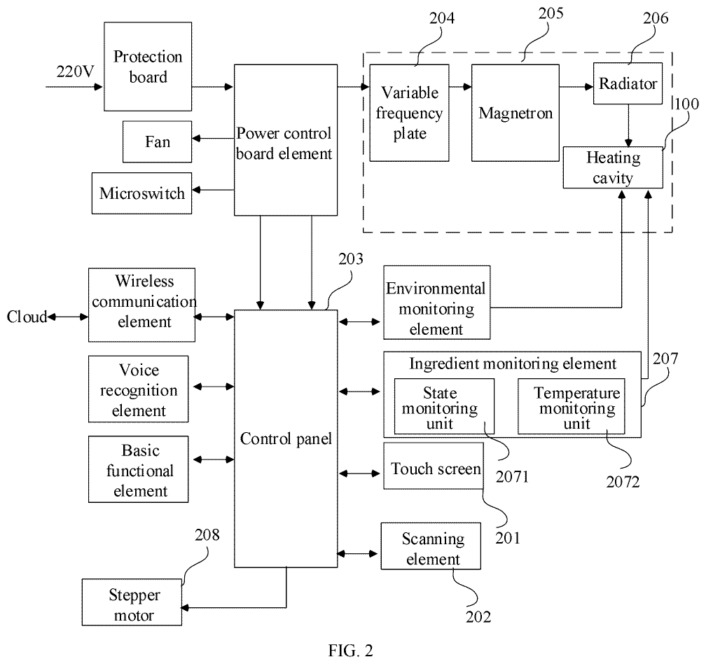

As illustrated in FIG. 1 and FIG. 2, embodiments of the present disclosure provide a cooking device. The cooking device includes a heating cavity 100, and an energy supply structure 200.

The heating cavity 100 is configured to accommodate a plurality of ingredients to be heated.

In some embodiments, the plurality of ingredients to be heated, e.g., milk, an egg, meat, and vegetable e.g., milk, an egg, meat, and vegetable, may be placed in the heating cavity 100 simultaneously, and positions of the plurality of ingredients to be heated in the heating cavity 100 remain the same.

The energy supply structure 200 is connected to the heating cavity 100, and is provided with a control panel 203, a magnetron 205, and a radiator 206.

The control panel 203 is configured to obtain state information on the plurality of ingredients to be heated, and generate a control instruction based on the plurality of ingredients to be heated. The state information includes a first temperature and a cooking attribute of each of the plurality of ingredients to be heated.

In some embodiments, the control panel 203 may be implemented based on an RK3568 smart board. In some embodiments, the control panel 203 may be disposed on an outer side of the heating cavity 100, and establishes a communication connection with the heating cavity 100 based on a network. In at least one embodiment, the control panel 203 is capable of allowing for a manual operation control or an automatic control by a user. For example, the heating cavity 100 has a touch screen 201 disposed on the outer side thereof, and the control panel 203 may establish a communication connection with the touch screen 201 based on the network.

In at least one embodiment, the touch screen 201 may be a 15.6″ touch screen 201 or a 7″ touch screen 201.

As illustrated in FIG. 2, the magnetron 205 is in a communication connection with the control panel 203. The magnetron 205 is configured to obtain an operation power based on the control instruction, and emit an operation electromagnetic wave to an interior of the heating cavity 100 based on the operation power

The radiator 206 is in a communication connection with the control panel 203. The radiator 206 is configured to determine a rotation speed and a radiation direction based on the control instruction, and radiate the operation electromagnetic wave to a plurality of heating positions in the interior of the heating cavity 100 based on the rotation speed and the radiation direction. The operation electromagnetic wave at the plurality of heating positions is used to heat each of the plurality of ingredients to be heated to a target temperature.

In at least one embodiment, the radiator 206 may be implemented based on a conventional antenna structure or radar structure for implementing radiation of the operation electromagnetic wave emitted by the magnetron 205 to any position in the interior of the heating cavity 100 by the radiator 206. In some embodiments, the radiator 206 is designed into a rotatable structure and connected to a waveguide 209. One end of the waveguide 209 is connected to the radiator 206, and the other end of the waveguide 209 has a mounting hole 210 defined thereon. The mounting hole 210 is configured to connect the waveguide 209 to the magnetron 205. The waveguide 209 is configured to receive the operation electromagnetic wave emitted from the magnetron 205 and conduct the received operation electromagnetic wave to the radiator 206.

In at least one embodiment, the radiation direction of the radiator 206 may be changed through transmitting the control instruction or a regulation instruction to the radiator 206 via the control panel 203 to control the radiator 206 to rotate, thereby realizing the radiation of the operation electromagnetic wave to any position in the interior of the heating cavity 100 at any time point based on the control instruction or the regulation instruction from the control panel 203.

In at least one embodiment, an implementation may be achieved on a basis of a smart microwave oven. That is, the above-mentioned structures or components are integrated into the smart microwave oven. When the plurality of ingredients to be heated is placed into a heating cavity 100 of the smart microwave oven simultaneously, each of the plurality of ingredients to be heated may be heated to the target temperature through control of the smart microwave oven.

In at least one embodiment, a load 101 is provided at a bottom of the heating cavity 100. The load 101 is disposed below the radiator 206, and configured to place the plurality of ingredients to be heated.

In some embodiments, as illustrated in FIG. 2, a variable frequency plate 204 is also included. The variable frequency plate 204 is provided with the energy supply structure, and is in a communication connection with the control panel 203.

The variable frequency plate 204 is configured to adjust the operation power based on the control instruction.

For example, the variable frequency plate 204 establishes the communication connection with the control panel 203 based on the network, and receives, based on the network, the control instruction or the regulation instruction transmitted by the control panel 203. The variable frequency plate 204 then changes the operation power of the magnetron 205 based on the control instruction or the regulation instruction, to adjust the operation electromagnetic wave emitted from the magnetron 205 into the interior of the heating cavity 100.

As illustrated in FIG. 2, in some embodiments, the radiator 206 is connected to a stepper motor 208. The stepper motor 208 is connected to the control panel 203. The control panel 203 is configured to adjust the rotation speed of the radiator 206 by controlling the stepper motor 208.

In at least one embodiment, the control panel 203 transmits the control instruction or the regulation instruction to the stepper motor 208 to change an operation state of the stepper motor 208. Different states of the stepper motor 208 correspond to different rotation states of the radiator 206, e.g., accelerated rotation, decelerated rotation, uniform rotation, or stationary, which solves a problem in the related art that a stirrer of the microwave oven can only rotate at a uniform speed. In this case, the operation electromagnetic wave can only be uniformly radiated to any position in the interior of the heating cavity 100, which can only realize uniform heating of one or more ingredients to be heated in the interior of the heating cavity 10, and simultaneous uneven heating of the ingredients cannot be realized, e.g., targeted heating based on the cooking attribute of each ingredient. However, in this embodiment of the present disclosure, the radiation direction of the operation electromagnetic wave can be altered by changing the rotation state of the radiator 206 to achieve, based on different cooking attributes of the plurality of ingredient to be heated, targeted uneven heating of the plurality of ingredients to be heated in the interior of the heating cavity 100, thereby eliminating the need to repeatedly take out and place different ingredients. Thus, it is possible to simplify heating operations, enhance the taste of each ingredient to be heated, and improve user satisfaction.

In some embodiments, the energy supply structure 200 is further provided with a waveguide. The waveguide is configured to receive the operation electromagnetic wave emitted by the magnetron 205 and conduct the operation electromagnetic wave to the radiator 206.

In some embodiments, the energy supply structure 200 is further provided with a scanning unit 202, and the scanning unit 202 is disposed on the outer side of the energy supply structure 200. The scanning unit 202 is in a communication connection with the control panel 203. The scanning unit 202 is configured to scan each of the plurality of ingredients to be heated to obtain the cooking attribute of each of the plurality of ingredients, and transmit the cooking attribute to the control panel 203.

When the user needs to heat the plurality of ingredients to be heated, each ingredient to be heated may be scanned by the scanning unit 202. After scanning each ingredient to be heated, the scanning unit 202 obtains the cooking attribute of each ingredient to be heated and transmits the cooking attribute of each ingredient to be heated to the control panel 203. In this way, the control panel 203 can quickly obtain the cooking attribute of each ingredient to be heated.

In at least one embodiment, an outer packaging of each ingredient to be heated may carry a unique identifier such as a QR code. The scanning unit 202 may obtain the cooking attribute of each ingredient to be heated by scanning the QR code. The cooking attribute may include a type of each ingredient to be heated, e.g., an egg, milk, vegetable, etc.

After obtaining the cooking attribute of each ingredient to be heated, the control panel 203 may call a cooking parameter for each ingredient to be heated based on a database built into the control panel 203, e.g., an optimal cooking period of time or an optimal cooking temperature, etc. After obtaining the optimal cooking temperature, the control panel 203 may set the optimal cooking temperature for each ingredient to be heated as its the target temperature.

When the cooking parameter for a certain ingredient to be heated is unavailable in the database, the control panel 203 may also obtain the cooking parameter from a cloud (not illustrated) based on the network.

As illustrated in FIG. 2, in some embodiments, an ingredient monitoring element 207 is disposed in the interior of the heating cavity 100. The ingredient monitoring element 207 establishes a communication connection with the control panel 203 based on the network, and includes a state monitoring unit 2071. The state monitoring unit 2071 establishes a communication connection with the control panel 203 based on the network.

The state monitoring unit 2071 is configured to monitor a real-time state of the plurality of ingredients to be heated that is in a heated state, and transmit monitored real-time state information to the control panel 203.

In at least one embodiment, the state monitoring unit 2071 may be implemented based on a camera (not illustrated). The camera monitors a real-time heated state of each ingredient to be heated during heating the plurality of ingredients to be heated, to obtain real-time heated state information. The real-time heated state information includes a first state and a second state. For example, the first state may be a liquid state, and the second state may be a solid state, a mixed liquid-solid state, etc.

As illustrated in FIG. 2, in some embodiments, the ingredient monitoring element 207 further includes a temperature monitoring unit 2072. The temperature monitoring unit 2072 is in a communication connection with the control panel 203. The temperature monitoring unit 2072 is configured to collect temperatures of the plurality of ingredients to be heated and transmit collected temperature information to the control panel 203.

In at least one embodiment, the temperature monitoring unit 2072 may be an infrared array sensor.

For example, 1) after the plurality of ingredients to be heated is placed into the heating cavity 100, temperature information on each ingredient to be heated may be collected by the infrared array sensor to obtain the first temperature of each ingredient to be heated. The first temperature of each ingredient to be heated is then transmitted to the control panel 203.

2) During heating the plurality of ingredients to be heated, a real-time temperature of each ingredient to be heated may be collected by the infrared array sensor, and collected real-time temperature information is transmitted to the control panel 203.

3) The control panel 203 may draw a real-time temperature map based on real-time temperatures of a plurality of points on a surface of each ingredient to be heated, for obtaining a temperature change of each point on the surface of each ingredient to be heated during heating each ingredient to be heated. The control panel 203 may also perform other subsequent calculations based on the real-time temperature map.

As illustrated in FIG. 2, in some embodiments, a power control board element (not illustrated) is also included. The power control board element establishes a communication connection with the control panel 203 based on the network to receive and execute the control instruction or the regulation instruction from the control panel 203. Also, the power control board element is connected to the control panel 203 to supply power to the control panel 203 at a voltage of 12V and a current of 3A.

The power control board element is connected to a protection board (not illustrated). The protection board is connected to a power supply device to conduct a supplied power by the power supply device to the power control board element. In addition, during conducting, the protection board performs a power conversion or the like on the supplied power to protect the power control board element and prevent damages to the power control board element due to excessive power of the supplied power.

As illustrated in FIG. 2, in some embodiments, the power control board element is connected to a plurality of fans (not illustrated) to supply power to the plurality of fans, which in turn cools the power control board element in operation to prevent a temperature of the power control board element from becoming too high.

As illustrated in FIG. 2, in some embodiments, the power control board element is connected to a microswitch (not illustrated) to supply power to the microswitch, which controls an operation state of the power control board element by means of activating or inactivating the power control board element.

As illustrated in FIG. 2, in some embodiments, the power control board element is connected to the variable frequency plate 204 to supply power to the variable frequency plate 204.

As illustrated in FIG. 2, in some embodiments, the power supply structure 200 is further provided with an environmental monitoring element (not illustrated). The environmental monitoring element includes a temperature sensor (not illustrated) and a burnt scent sensor (not illustrated). Each of the temperature sensor and the burnt scent sensor establishes a communication connection with the control panel 203 based on the network.

In at least one embodiment, the burnt scent sensor is configured to collect a smell in an environment in real time, and transmit, in response to detecting a burnt scent in the environment, burnt scent information to the control panel 203.

In at least one embodiment, the temperature sensor is configured to collect an ambient temperature and transmit collected ambient temperature information to the control panel 203.

As illustrated in FIG. 2, in some embodiments, the control panel 203 is connected to a wireless communication element (not illustrated), to enable the control panel 203 to establish data interaction with various components of the cooking device and the cloud (not illustrated) based on the network. The wireless communication element may include: a combination of WIFI (not illustrated) and BT (not illustrated), a 4G unit (not illustrated), a UHF reader (not illustrated), and a Zigbee communication unit (not illustrated).

As illustrated in FIG. 2, in some embodiments, the control panel 203 is connected to a speech recognition element (not illustrated) to allow the user to perform speech interaction with the control panel 203 via the speech recognition element.

In at least one embodiment, the speech recognition element includes a MIC array board (not illustrated). The MIC array board can be configured to collect the user's voice and transmit collected information about the user's voice to the control panel 203. For example, the user provides feedback of his/her requirement (e.g., operation power, heating time, etc., of the magnetron 205) to the control panel 203 based on the MIC array board.

As illustrated in FIG. 2, in some embodiments, the speech recognition element further includes a speaker (not illustrated). The speaker is configured to receive the control instruction or the regulation instruction from the control panel 203 to provide the heating state of the plurality of ingredients to be heated in the interior of the heating cavity 100 to the user in a form of sound. For example, the speaker may broadcast an average temperature of the plurality of ingredients to be heated to the user.

As illustrated in FIG. 2, in some embodiments, the control panel 203 is provided with a basic functional element (not illustrated). The basic functional element includes a plurality of interfaces (not illustrated), a millimeter wave radar (not illustrated), a touch button (not illustrated), the scanning unit 202, and an NFC unit (not illustrated). The scanning unit 202 and the NFC unit are integrated, which saves space for the basic functional element.

In at least one embodiment, the plurality of interfaces includes a UART interface (not illustrated), a USB interface (not illustrated), and a 485 interface (not illustrated). The control panel 203 can realize data interaction with various components of the cooking device based on the plurality of interfaces.

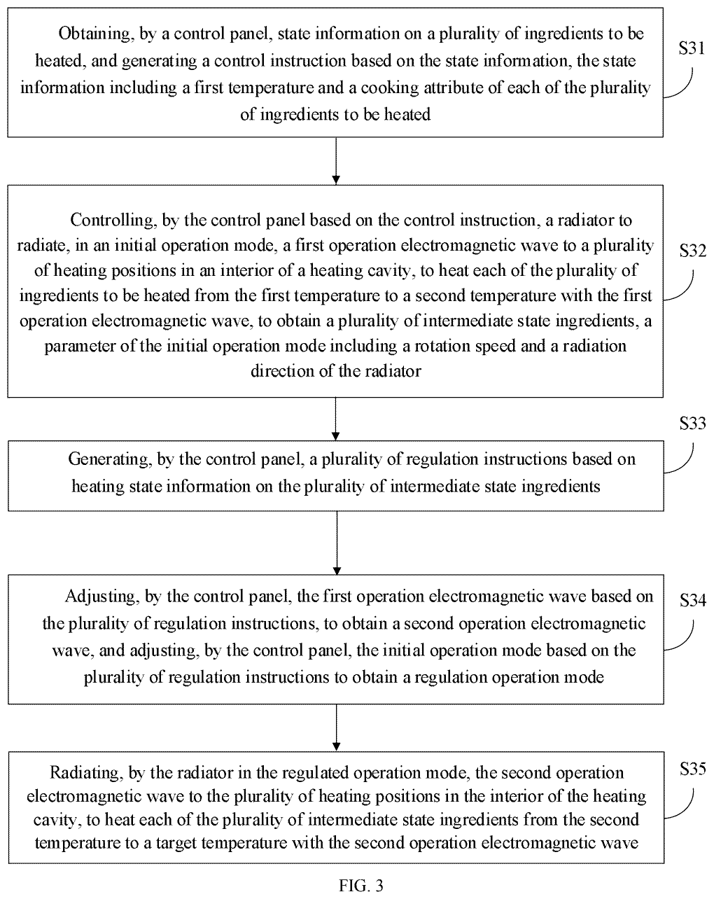

As illustrated in FIG. 3, embodiments of the present disclosure further provide a cooking method, which is applied in the above system. The method includes actions at blocks S31 to S35.

At block S31, a control panel 203 obtains state information on a plurality of ingredients to be heated, and generates a control instruction based on the state information. The state information includes a first temperature and a cooking attribute of each of the plurality of ingredients to be heated.

Generally, conventional microwave ovens can only cook one type of food at one time. For a conventional microwave oven, when a plurality of ingredients needs to be heated, e.g., a breakfast may include a plurality of ingredients such as an egg, milk, etc., one of the plurality of ingredients of the breakfast needs to be heated first. After the one of the plurality of ingredients has been heated, the ingredient should be removed from the microwave oven and another ingredient is then placed into the microwave oven to be heated, and so on. To heat the plurality of ingredients of the breakfast, several times of taking out and placement of the ingredients are necessary, which results in complicated operations and long waiting time. To solve problems of complicated operations and long waiting time due to several times of taking out and placement of the ingredients, embodiments of the present disclosure provide the following technical solutions.

In some embodiments, the control panel 203 scans the QR code on the outer packaging of each ingredient to be heated based on the scanning unit 202, to obtain the cooking attribute of each ingredient to be heated, which is simple and quick to operate. For example, types of ingredients to be heated may include an egg, milk, meat, vegetable, etc.

Each ingredient to be heated includes only one ingredient. For example, each ingredient to be heated may be an egg, milk, meat, or vegetable, etc.

After obtaining the cooking attribute of each ingredient to be heated, the control panel 203 obtains a cooking parameter for each ingredient to be heated based on database built into the control panel 203, e.g., an optimal cooking period of time or an optimal cooking temperature for each ingredient to be heated, and then sets the optimal cooking temperature obtained based on the database as a target temperature for the ingredient to be heated.

In at least one embodiment, after obtaining that the plurality of ingredients to be heated includes milk, meat, vegetable, and an egg, the control panel 203 obtains an optimal cooking temperature for each of the milk, meat, vegetable, and egg based on the database, and obtains a target temperature for each of the milk, meat, vegetable, and egg.

In at least one embodiment, when the control panel 203 is unable to find an optimal cooking temperature for a particular meat material from the database for a reason that a limited database storage space of the control panel 203 cannot store the cooking parameter for each ingredient, the control panel 203 may obtain the optimal cooking temperature for the meat material from a cloud based on the network. Therefore, to address the problem of the limited database storage space, the control panel 203 is allowed to be connected to the cloud based on the network.

At block S32, the control panel 203 controls, based on the control instruction, the radiator 206 to radiate, in an initial operation mode, a first operation electromagnetic wave to a plurality of heating positions in an interior of the heating cavity 100, to heat each of the plurality of ingredients to be heated from the first temperature to a second temperature with the first operation electromagnetic wave, to obtain a plurality of intermediate state ingredients. A parameter of the initial operation mode includes a rotation speed and a radiation direction of the radiator 206.

In some embodiments, after the plurality of ingredients to be heated is placed in the interior of the heating cavity 100, the heating cavity 100 is closed. The control panel 203 generates the control instruction based on the obtained state information on each ingredient to be heated, and transmits the control instruction to a variable frequency plate 204. The variable frequency plate 204 adjusts, upon receiving the control instruction, power to initial operation power, and controls the magnetron 205 to emit the first operation electromagnetic wave at the initial operation power.

Meanwhile, the control panel 203 transmits the control instruction to the radiator 206. The radiator 206 enters the initial operation mode based on the control instruction, and radiates, in the initial operation mode, the first operation electromagnetic wave to the plurality of heating positions in the interior of the heating cavity 100.

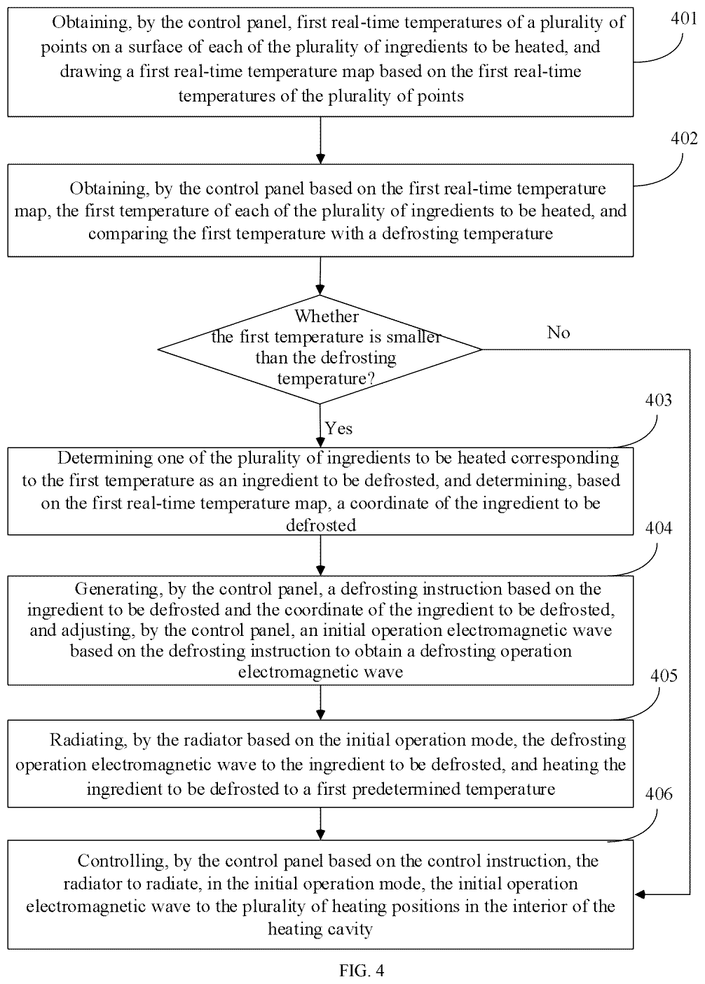

As illustrated in FIG. 4, in some embodiments, the cooking method further includes, prior to controlling, by the control panel 203 based on the control instruction, the radiator 206 to radiate, in the initial operation mode, the first operation electromagnetic wave to the plurality of heating positions in the interior of the heating cavity 100, actions at block S401 to S406.

At block S401, the control panel 203 obtains first real-time temperatures of a plurality of points on a surface of each of the plurality of ingredients to be heated, and draws a first real-time temperature map based on the first real-time temperatures of the plurality of points.

At block S402, the control panel 203 obtains, based on the first real-time temperature map, the first temperature of each of the plurality of ingredients to be heated, and compares the first temperature with a defrosting temperature.

At block S403, in response to the first temperature being smaller than the defrosting temperature, one of the plurality of ingredients to be heated corresponding to the first temperature is determined as an ingredient to be defrosted, and a coordinate of the ingredient to be defrosted is determined based on the first real-time temperature map.

At block S404, the control panel 203 generates a defrosting instruction based on the ingredient to be defrosted and the coordinate of the ingredient to be defrosted, and adjusts the first operation electromagnetic wave based on the defrosting instruction to obtain a defrosting operation electromagnetic wave.

At block S405, the radiator 206 radiates, based on the initial operation mode, the defrosting operation electromagnetic wave to the ingredient to be defrosted, to heat the ingredient to be defrosted to a first predetermined temperature.

At block S406, the control panel 203 controls, based on the control instruction, the radiator 206 to radiate, in the initial operation mode, an initial operation electromagnetic wave to the plurality of heating positions in the interior of the heating cavity 100.

In at least one embodiment, the defrosting temperature and the first predetermined temperature are predetermined, and stored in the database of the control panel 203 for subsequent calls by an algorithm.

In some embodiments, an infrared array sensor collects the first temperature of each of the plurality of ingredients to be heated placed in the interior of the heating cavity 100, and transmits the collected first temperature of each of the plurality of ingredients to be heated to the control panel 203. The first temperature is an average temperature of each ingredient to be heated. That is, when a first temperature of a certain ingredient to be defrosted is smaller than the defrosting temperature, it indicates that the ingredient to be defrosted is in a to-be-defrosted state as a whole. For the first heating temperature of each ingredient to be heated, the first real-time temperatures of the plurality of points on the surface of each ingredient to be heated may be obtained based on the first real-time temperature map, and an average value may be calculated based on the first real-time temperatures of the plurality of points. The average value is determined as the first temperature.

All the first obtained temperatures are compared with the defrosting temperature, respectively. In response to the first temperature of at least one ingredient to be heated being smaller than the defrosting temperature, the control panel 203 obtains a coordinate of the at least one ingredient to be heated whose first temperature is smaller than the defrosting temperature, generates the defrosting instruction based on the first temperature smaller than the defrosting temperature and the coordinate of the at least one ingredient to be heated whose first temperature is smaller than the defrosting temperature, and transmits the defrosting instruction to the variable frequency plate 204 and the radiator 206.

The variable frequency plate 204 controls, based on the obtained defrosting instruction, the magnetron 205 to emit a defrosting operation electromagnetic wave at defrosting operation power.

The radiator 206 determines a direction of defrosting radiation based on coordinate information contained in the obtained defrosting instruction.

The radiator 206 radiates the defrosting operation electromagnetic wave in the direction of defrosting radiation based on an initial rotation speed to heat the ingredient to be defrosted.

During heating the ingredient to be defrosted, the infrared array sensor collects real-time heating temperature information on the ingredient to be defrosted in a defrost state and, transmits collected real-time temperature information to the control panel 203.

The control panel 203 calculates a real-time average temperature value of the ingredient to be defrosted based on the received real-time heating temperature information, compares the real-time temperature average value with the first predetermined temperature, and controls, in response to the real-time temperature average value being greater than the first predetermined temperature, the magnetron 205 to stop emitting the defrosting operation electromagnetic wave.

In at least one embodiment, an egg, milk, beef, and vegetable are simultaneously placed in the interior of the heating cavity 100. In response to detecting that a first temperature of the beef is smaller than the defrosting temperature, the control panel 203 obtains a coordinate of the beef based on the first real-time temperature map and generates the defrosting instruction.

The control panel 203 transmits the defrosting instruction to the variable frequency plate 204 and the radiator 206.

The variable frequency plate 204 controls, based on the defrosting instruction, the magnetron 205 to emit the defrosting operation electromagnetic wave at the defrosting operation power.

The radiator 206 radiates the defrosting operation electromagnetic wave to the coordinate of the beef based on the defrosting instruction.

The beef is heated by the defrosting operation electromagnetic wave from the first temperature to the first predetermined temperature. When a real-time temperature average value of the beef reaches the first predetermined temperature at a certain time point, it indicates that the defrosting of the beef is completed.

In at least one embodiment, when the beef in the to-be-defrosted state is large in volume, the control plate 203 may control the radiator 206 to rotate at a constant speed (e.g., 10 degrees/3 seconds) while the radiator 206 is controlled to radiate the defrosting operation electromagnetic wave to a position where the beef is located. The radiator 206 rotates in a region where the beef is located, and does not heat other ingredients that are not in the to-be-defrosted state, e.g., the egg, milk, etc.

In some embodiments, the cooking method further includes, prior to controlling, by the control panel 203 based on the control instruction, the radiator 206 to radiate, in the initial operation mode, the first operation electromagnetic wave to the plurality of heating positions in the interior of the heating cavity 100: obtaining, by the control panel 203 every first predetermined period of time, second real-time temperatures of the plurality of points on the surface of each of the plurality of ingredients to be heated, and drawing, by the control panel 203, a second real-time temperature map based on the second real-time temperatures of the plurality of points; obtaining, by the control panel 203, temperature rise rates of the plurality of points based on the second real-time temperature map; determining a target temperature rise rate based on the temperature rise rates of the plurality of points; and determining an initial rotation speed of the radiator 206 based on the target temperature rise rate.

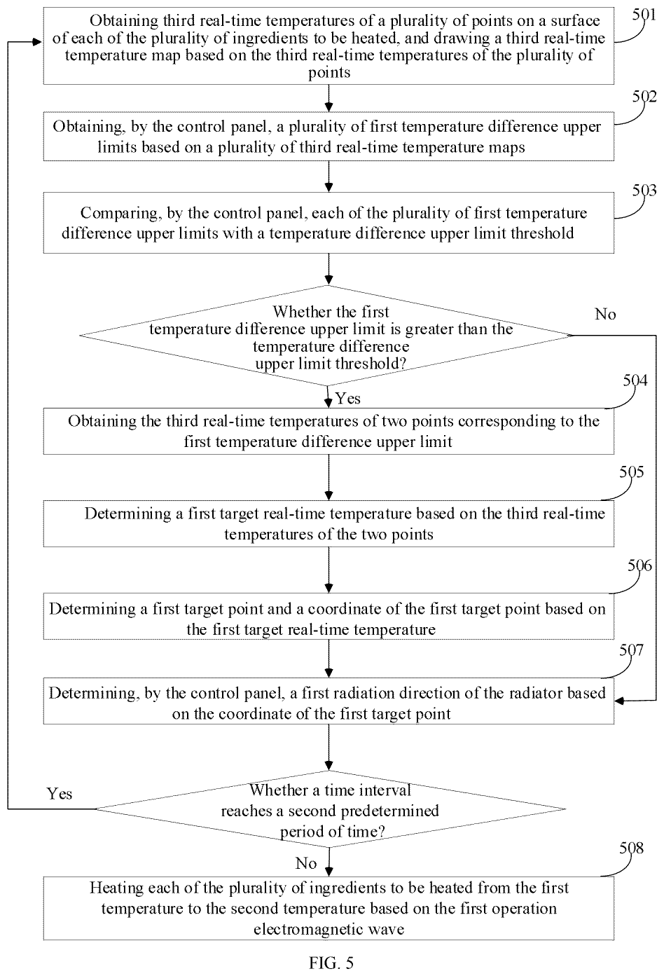

As illustrated in FIG. 5, in some embodiments, the controlling, by the control panel 203 based on the control instruction, the radiator 206 to radiate, in the initial operation mode, the first operation electromagnetic wave to the plurality of heating positions in the interior of the heating cavity 100 includes: determining, by the control panel 203, the first operation electromagnetic wave based on the cooking attribute of each of the plurality of ingredients to be heated.

At block 501, the control panel 203 obtains, every second predetermined period of time, third real-time temperatures of the plurality of points on the surface of each of the plurality of ingredients to be heated, and draws a third real-time temperature map based on the third real-time temperatures of the plurality of points.

At block 502, the control panel 203 obtains a plurality of first temperature difference upper limits based on a plurality of third real-time temperature maps.

At block 503, the control panel 203 compares each of the plurality of first temperature difference upper limits with a temperature difference upper limit threshold.

At block 504, in response to the first temperature difference upper limit being greater than the temperature difference upper limit threshold, the third real-time temperatures of two points corresponding to the first temperature difference upper limit are obtained.

At block 505, a first target real-time temperature is determined based on the third real-time temperatures of the two points.

At block 506, a first target point and a coordinate of the first target point are determined based on the first target real-time temperature.

At block 507, the control panel 203 determines a first radiation direction of the radiator 206 based on the coordinate of the first target point.

The radiator 206 radiates the first operation electromagnetic wave to the interior of the heating cavity 100 in the first radiation direction based on the initial rotation speed, to heat the ingredient to be heated that is located in the first radiation direction with the first operation electromagnetic wave.

At block 508, each of the plurality of ingredients to be heated is heated from the first temperature to the second temperature based on the first operation electromagnetic wave.

In at least one embodiment, after the defrosting of the beef has been completed, simultaneous heating of the egg, milk, beef, and vegetable placed in the interior of the heating cavity 100 is performed.

The control panel 203 controls, by controlling the stepper motor 208, the radiator 206 to change the rotation speed every first predetermined period of time, and updates the second real-time temperature map while changing the rotation speed to obtain an average temperature rise rate of all the ingredients to be heated. The average temperature rise rate of all the ingredients to be heated may be obtained by calculating a temperature of each point on the second real-time temperature map.

For example, the radiator 206 starts rotating at a predetermined rotation speed of 10 degrees/3 seconds, updates the real-time temperature map every 3 seconds, changes the predetermined rotation speed of the radiator 206, and continues operating at the changed rotation speed.

Average temperature rise rates obtained via several calculations are compared with each other to obtain a maximum average temperature rise rate for the egg, milk, beef, and vegetable. Also, a rotation speed corresponding to the maximum average temperature rise rate is obtained.

The radiator 206 determines the initial rotation speed based on the rotation speed corresponding to the maximum average temperature rise rate, and radiates the first operation electromagnetic wave to the egg, milk, beef, and vegetable sequentially based on the initial rotation speed to perform heating on the egg, milk, beef, and vegetable simultaneously and heat the egg, milk, beef, and vegetable to respective second temperatures.

In at least one embodiment, during the heating of the egg, milk, beef, and vegetable to respective second temperatures, the control panel 203 determines the first operation electromagnetic wave based on the cooking attributes of the egg, milk, beef, and vegetable.

The control panel 203 obtains third real-time temperatures of a plurality of points on a surface of each of the egg, milk, beef, and vegetable every second predetermined period of time and draws the third real-time temperature map based on the third real-time temperatures of the plurality of points. The third real-time temperature map may characterize temperature changes during the heating of the egg, milk, beef, and vegetable to respective second temperatures.

The control panel 203 obtains a plurality of first temperature difference upper limits based on a plurality of third real-time temperature maps formed during the heating of the egg, milk, beef, and vegetable to respective second temperatures.

The control panel 203 compares each first temperature difference upper limit with the threshold of the temperature difference upper limit threshold.

In response to the first temperature difference upper limit being greater than the temperature difference upper limit threshold, the third real-time temperatures of two points corresponding to the first temperature difference upper limit are obtained.

The first target real-time temperature is determined based on the third real-time temperatures of the two points, e.g., two points on the surface of the beef.

The control panel 203 determines the first radiation direction of the radiator 206 based on coordinates of the two points on the surface of the beef.

The radiator 206 radiates the first operation electromagnetic wave to the interior of the heating cavity 100 in the first radiation direction based on the initial rotation speed, to heat the beef located in the first radiation direction with the first operation electromagnetic wave.

By analogy, the above steps are repeated, until the real-time temperature average value of the surface of each of the egg, milk, beef, and vegetable is greater than a respective second temperature.

It should be noted that the first predetermined temperature and the second temperature may be predetermined or adjusted as desired, and are not specifically limited in the embodiments of the present disclosure.

At block S33, the control panel 203 generates a plurality of regulation instructions based on heating state information on the plurality of intermediate state ingredients.

At block S34, the control panel 203 adjusts the first operation electromagnetic wave based on the plurality of regulation instructions to obtain a second operation electromagnetic wave, and adjusts the initial operation mode based on the plurality of regulation instructions to obtain a regulation operation mode.

At block S35, the radiator 206 radiates, in the regulation operation mode, the second operation electromagnetic wave to the plurality of heating positions in the interior of the heating cavity 100, to heat each of the plurality of intermediate state ingredients from the second temperature to a target temperature with the second operation electromagnetic wave.

In the embodiments of the present disclosure, during the heating of the plurality of ingredients to be heated, the operation electromagnetic wave of the magnetron 205 and the radiation direction of the radiator 206 can be determined based on the cooking attribute, the first temperature, and the cooking parameter of each ingredient to be heated, to heat each ingredient to be heated to a respective target temperature. In addition, after all the ingredients to be heated have reached their respective target temperatures, the heated ingredients can be taken out simultaneously, which not only satisfies the user's need to heat the plurality of ingredients to be heated simultaneously, but also ensures the taste of each ingredient to be heated.

In some embodiments, radiating, by the radiator 206 in the regulation operation mode, the second operation electromagnetic wave to the plurality of heating positions in the interior of the heating cavity 100, to heat each of the plurality of intermediate state ingredients from the second temperature to the target temperature with the second operation electromagnetic wave includes: determining, by the control panel 203, the second operation electromagnetic wave based on the cooking attribute of each of the plurality of intermediate state ingredients; determining, by the control panel 203, a type of each of the plurality of intermediate state ingredients, the type including a homogenized ingredient, non-homogenized ingredient, and a mixed ingredient; generating, by the control panel 203 based on the type, the regulation instruction corresponding to the type; regulating, by the control panel 203, an initial rotation speed based on the regulation instruction to obtain a regulation rotation speed; radiating, by the radiator 206, the second operation electromagnetic wave to the plurality of heating positions in the interior of the heating cavity 100 based on the regulation rotation speed; and heating, based on the second operation electromagnetic wave at the plurality of heating positions, each of the plurality of intermediate state ingredients from the second temperature to the target temperature.

In some embodiments, generating, by the control panel 203 based on the type, the regulation instruction corresponding to the type includes: generating, by the control panel 203 in response to the intermediate state ingredient being the homogenized ingredient, a first regulation instruction based on the homogenized ingredient; generating, by the control panel 203 in response to the intermediate state ingredient being the non-homogenized ingredient, a second regulation instruction based on the non-homogenized ingredient; and generating, by the control panel 203 in response to the intermediate state ingredient being the mixed ingredient, a third regulation instruction based on the mixed ingredient.

In some embodiments, the plurality of ingredients to be heated may be of a plurality of types, e.g., the homogenized ingredient, the non-homogenized ingredient, and the mixed ingredient.

The homogenized ingredient may mean that each of the plurality ingredients to be heated is liquid ingredient. For example, each of the plurality of ingredients to be heated may be milk of different types.

The non-homogenized ingredient may mean that none of the plurality of ingredients to be heated is a liquid ingredient. For example, each of the plurality of ingredients to be heated is meat.

The mixed ingredient may mean that the plurality of ingredients to be heated includes both liquid and non-liquid ingredients. For example, a raw egg may be a liquid ingredient in an early stage of heating, a mixed liquid-solid ingredient in a middle stage of heating, and a solid (non-liquid) ingredient in a later stage of heating. Or, the plurality of ingredients to be heated may include milk, meat, and vegetable simultaneously.

During the heating of each of the plurality of ingredients to be heated of different types from the second temperature to the target temperature, different heating solutions are provided to the plurality of ingredients to be heated of different types.

In some embodiments, generating, by the control panel 203 in response to the intermediate state ingredient being the homogenized ingredient, the first regulation instruction based on the homogenized ingredient includes: regulating, by the control panel 203, the initial rotation speed based on the first regulation instruction, to obtain a first regulation rotation speed; and radiating, by the radiator 206, the second operation electromagnetic wave to the plurality of heating positions in the interior of the heating cavity 100 based on the first regulation rotation speed.

In some embodiments, the cooking method further includes, subsequent to generating, by the control panel 203 in response to the intermediate state ingredient being the non-homogenized ingredient, the second regulation instruction based on the non-homogenized ingredient: regulating, by the control panel 203, the initial rotation speed based on the second regulation instruction to obtain a second regulation rotation speed; and radiating, by the radiator 206, the second operation electromagnetic wave to the plurality of heating positions in the interior of the heating cavity 100 based on the second regulation rotation speed.

In some embodiments, radiating, by the radiator 206, the second operation electromagnetic wave to the plurality of heating positions in the interior of the heating cavity 100 based on the second regulation rotation speed includes: obtaining, by the control panel 203 every third predetermined period of time, fourth real-time temperatures of the plurality of points on the surface of each of the plurality of intermediate state ingredients, and drawing, by the control panel 203, a fourth real-time temperature map based on the fourth real-time temperatures of the plurality of points; obtaining, by the control panel 203, a plurality of second temperature difference upper limits based on the plurality of fourth real-time temperature maps; comparing, by the control panel 203, each of the plurality of second temperature difference upper limits with a temperature difference upper limit threshold; obtaining, in response to the second temperature difference upper limit being greater than the temperature difference upper limit threshold, the fourth real-time temperatures of two points corresponding to the second temperature difference upper limit; determining a second target real-time temperature based on the fourth real-time temperatures of the two points; determining a second target point and a coordinate of the second target point based on the second target real-time temperature; determining, by the control panel 203, a second radiation direction of the radiator 206 based on the coordinate of the second target point; and radiating, by the radiator 206, the second operation electromagnetic wave to the second radiation direction in the interior of the heating cavity 100 based on the initial rotation speed, to heat the intermediate state ingredient that is located in the second radiation direction with the second operation electromagnetic wave.

The above steps are repeated, until each intermediate state ingredient is heated to the respective target temperature.

In some embodiments, a current coordinate of the radiator 206 is obtained. An angle at which the radiator 206 needs to be rotated is calculated based on the current coordinate of the radiator 206 and the coordinate of the second target point. Then, the control panel 203 controls the radiator 206 to rotate by the previously-calculated angle at which the radiator 206 needs to be rotated from the current radiation direction, enabling the radiator 206 to move from the first radiation direction to the second radiation direction.

For example, a current coordinate is (a,b), and a coordinate of the second target point is (c,d). Based on the current coordinate (a,b) and the coordinate of the second target point (c,d), the angle at which the rotator 206 needs to be rotated (e.g., clockwise) is calculated to be A degrees. The control panel 203 controls the radiator 206 to rotate clockwise by A degrees from the current radiation direction, enabling the radiator 206 to move from the first radiation direction to the second radiation direction.

In some embodiments, the cooking method further includes, subsequent to generating, by the control panel 203 in response to the intermediate state ingredient being the mixed ingredient, the third regulation instruction based on the mixed ingredient: obtaining, by the control panel 203 every fourth predetermined period of time, the heating state information on the plurality of intermediate state ingredients, the heating state information including a first state and a second state; regulating, by the control panel 203 in response to the plurality of intermediate state ingredients being in the first state, the initial rotation speed based on the third regulation instruction, to obtain a third regulation rotation speed; and radiating, by the radiator 206, the second operation electromagnetic wave to the plurality of heating positions in the interior of the heating cavity 100 based on the third regulation rotation speed.

It should be noted that the first regulation rotation speed, the second regulation rotation speed, and the third regulation rotation speed involved in the embodiments of the present disclosure are not directly related to each other. That is, the first regulation rotation speed, the second regulation rotation speed, and the third regulation rotation speed may be or not be equal to each other. The first regulation rotation speed, the second regulation rotation speed, and the third regulation rotation speed correspond to intermediate state ingredients of different types, and each of the first regulation rotation speed, the second regulation rotation speed, and the third regulation rotation speed is determined based on the cooking attribute and the cooking parameter of the corresponding intermediate state ingredient.

In some embodiments, the cooking method further includes: obtaining, by the control panel 203 every fifth predetermined period of time in response to the plurality of intermediate state ingredients being in the second state, fifth real-time temperatures of a plurality of points on a surface of each of the plurality of intermediate state ingredients, and drawing, by the control panel 203, a fifth real-time temperature map based on the fifth real-time temperatures of the plurality of points; obtaining, by the control panel 203, a plurality of third temperature difference upper limits based on the plurality of fifth real-time temperature maps; comparing, by the control panel 203, each of the plurality of third temperature difference upper limits with a temperature difference upper limit threshold; obtaining, in response to the third temperature difference upper limit being greater than the threshold of the temperature difference upper limit, the fifth real-time temperatures of two points corresponding to the third temperature difference upper limit; determining a third target real-time temperature based on the fifth real-time temperatures of the two points; determining a third target point and a coordinate of the third target point based on the third target real-time temperature; determining, by the control panel 203, a third radiation direction of the radiator 206 based on the coordinate of the third target point; and radiating, by the radiator 206, the second operation electromagnetic wave to the third radiation direction in the interior of the heating cavity 100 based on the third regulation rotation speed, to heat the intermediate state ingredient in the third radiation direction with the second operation electromagnetic wave.

The above steps are repeated, until each intermediate state ingredient is heated to the respective target temperature.

In at least one embodiment, the plurality of intermediate state ingredients reaches respective target temperatures simultaneously when an absolute value of a difference between the target temperatures of any two intermediate state ingredients is smaller than or equal to the temperature difference upper limit threshold.

In at least one embodiment, when the absolute value of the difference between the target temperatures of two intermediate state ingredients is greater than the temperature difference upper limit threshold, the plurality of intermediate state ingredients reaches respective target temperatures at different time points. The intermediate state ingredient having a lowest target temperature is heated to its target temperature first. The intermediate state ingredient having a highest target temperature is heated to its target temperature last. When the intermediate state ingredient having the lowest target temperature is heated to its target temperature, the control panel 203 controls the radiator 206 to stop radiating the second operation electromagnetic wave to a position where a coordinate of the intermediate state ingredient is located, i.e., to stop heating the intermediate state ingredient.

In some embodiments, heating, based on the second operation electromagnetic wave at the plurality of heating positions, each of the plurality of intermediate state ingredients from the second temperature to the target temperature further includes: heating an N-th intermediate state ingredient to an N-th target temperature at an M-th time point based on the second operation electromagnetic wave; and heating an (N+1)-th intermediate state ingredient to an (N+1)-th target temperature at an L-th time point based on the second operation electromagnetic wave, where N≥1, N is an integer, and M, L≥0.

According to the embodiments of the present disclosure, each ingredient to be heated can be heated to the respective target temperature based on its corresponding cooking parameter, without the need for reheating or repeatedly taking out and placing ingredients, which solves a problem of overheating or undercooking of a certain ingredient resulted from heating the plurality of ingredients to be heated simultaneously.

In at least one embodiment, the temperature difference upper limit threshold is 5° C. Suppose a target temperature of one intermediate state ingredient that is an egg is 75° C., a target temperature of one intermediate state ingredient that is vegetable is 60° C., a target temperature of one intermediate state ingredient that is milk is 50° C., and a target temperature of one intermediate state ingredient that is beef is 90° C. It can be obtained that an absolute value of a difference between the target temperatures of any two intermediate state ingredients is greater than the temperature difference upper limit threshold. Therefore, the milk is heated to 50° C. at a first time point; the vegetable is heated to 60° C. at a second time point; the egg is heated to 75° C. at a third time point; and the beef is heated to 90° C. at a fourth time point. Chronologically, the first time point, the second time point, the third time point, and the fourth time point are sequenced as: the first time point, the second time point, the third time point, the fourth time point. After the beef has been heated to 90° C., the control panel 203 controls the magnetron 205 to stop operating.

In at least one embodiment, the temperature difference upper limit threshold is 5° C. Suppose a target temperature of one intermediate state ingredient that is an egg is 75° C., a target temperature of one intermediate state ingredient that is vegetable is 60° C., a target temperature of one intermediate state ingredient that is milk is 50° C., and a target temperature of one intermediate state ingredient that is porridge is 78° C. It can be obtained that an absolute value of a difference between the target temperatures of any two intermediate state ingredients is greater than the temperature difference upper limit threshold. Therefore, the milk is heated to 50° C. at a first time point; the vegetable is heated to 60° C. at a second time point; and both the egg and the porridge are heated to 78° C. at a third time point. Chronologically, the first time point, the second time point, and the third time point are sequenced as: the first time point, the second time point, the third time point. After the porridge has been heated to 78° C., the control panel 203 controls the magnetron 205 to stop operating.

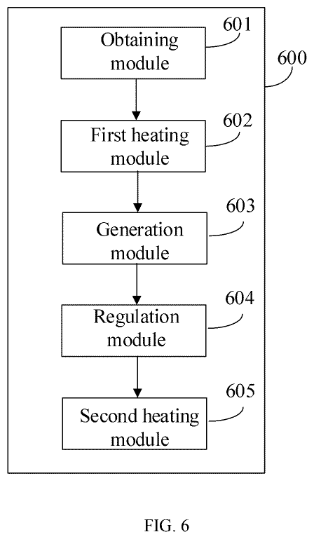

As illustrated in FIG. 6, embodiments of the present disclosure further provide a cooking apparatus 600. The cooking apparatus 600 includes an obtaining module 601, a first heating module 602, a generation module 603, a regulation module 604, and a second heating module 605.

The obtaining module 601 is configured to obtain, by a control panel 203, state information on a plurality of ingredients to be heated, and generate, by the control panel 203, a control instruction based on the state information. The state information includes a first temperature and a cooking attribute of each of the plurality of ingredients to be heated.

The first heating module 602 is configured to control, by the control panel 203 based on the control instruction, a radiator 206 to radiate, in an initial operation mode, a first operation electromagnetic wave to a plurality of heating positions in an interior of a heating cavity 100, to heat each of the plurality of ingredients to be heated from the first temperature to a second temperature with the first operation electromagnetic wave, to obtain a plurality of intermediate state ingredients. A parameter of the initial operation mode includes a rotation speed and a radiation direction of the radiator 206.

The generation module 603 is configured to generate, by the control panel 203, a plurality of regulation instructions based on heating state information on the plurality of intermediate state ingredients.

The regulation module 604 is configured to adjust, by the control panel 203, the first operation electromagnetic wave based on the plurality of regulation instructions, to obtain a second operation electromagnetic wave, and adjust, by the control panel 203, the initial operation mode based on the plurality of regulation instructions to obtain a regulation operation mode.

The second heating module 605 is configured to radiate, by the radiator 206 in the regulation operation mode, the second operation electromagnetic wave to the plurality of heating positions in the interior of the heating cavity 100, to heat each of the plurality of intermediate state ingredients from the second temperature to a target temperature with the second operation electromagnetic wave.

In some embodiments, the cooking apparatus 600 is further configured to, prior to controlling, by the control panel 203 based on the control instruction, the radiator 206 to radiate, in the initial operation mode, the first operation electromagnetic wave to the plurality of heating positions in the interior of the heating cavity 100: obtain, by the control panel 203, first real-time temperatures of a plurality of points on a surface of each of the plurality of ingredients to be heated, and drawing a first real-time temperature map based on the first real-time temperatures of the plurality of points; obtain, by the control panel 203 based on the first real-time temperature map, the first temperature of each of the plurality of ingredients to be heated, and compare the first temperature with a defrosting temperature; determine, in response to the first temperature being smaller than the defrosting temperature, one of the plurality of ingredients to be heated corresponding to the first temperature as an ingredient to be defrosted, and determine, based on the first real-time temperature map, a coordinate of the ingredient to be defrosted; generate, by the control panel 203, a defrosting instruction based on the ingredient to be defrosted and the coordinate of the ingredient to be defrosted, and adjust, by the control panel 203, the first operation electromagnetic wave based on the defrosting instruction to obtain a defrosting operation electromagnetic wave; and radiate, by the radiator 206 based on the initial operation mode, the defrosting operation electromagnetic wave to the ingredient to be defrosted, and heat the ingredient to be defrosted to a first predetermined temperature.

In some embodiments, the cooking apparatus 600 is further configured to, prior to controlling, by the control panel 203 based on the control instruction, the radiator 206 to radiate, in the initial operation mode, the first operation electromagnetic wave to the plurality of heating positions in the interior of the heating cavity 100: obtain, by the control panel 203 every first predetermined period of time, second real-time temperatures of a plurality of points on a surface of each of the plurality of ingredients to be heated, and draw a second real-time temperature map based on the second real-time temperatures of the plurality of points; obtain, by the control panel 203, temperature rise rates of the plurality of points based on the second real-time temperature map; determine a target temperature rise rate based on the temperature rise rates of the plurality of points; and determine an initial rotation speed of the radiator 206 based on the target temperature rise rate.

In some embodiments, controlling, by the control panel 203 based on the control instruction, the radiator 206 to radiate, in the initial operation mode, the first operation electromagnetic wave to the plurality of heating positions in the interior of the heating cavity 100 includes: determining, by the control panel 203, the first operation electromagnetic wave based on the cooking attribute of each of the plurality of ingredients to be heated; obtaining, by the control panel 203 every second predetermined period of time, third real-time temperatures of a plurality of points on a surface of each of the plurality of ingredients to be heated, and drawing a third real-time temperature map based on the third real-time temperatures of the plurality of points; obtaining, by the control panel 203, a plurality of first temperature difference upper limits based on ae plurality of third real-time temperature maps; comparing, by the control panel 203, each of the plurality of first temperature difference upper limits with a temperature difference upper limit threshold; obtaining, in response to the first temperature difference upper limit being greater than the temperature difference upper limit threshold, the third real-time temperatures of two points corresponding to the first temperature difference upper limit; determining a first target real-time temperature based on the third real-time temperatures of the two points; determining a first target point and a coordinate of the first target point based on the first target real-time temperature; determining, by the control panel 203, a first radiation direction of the radiator 206 based on the coordinate of the first target point; and radiating, by the radiator 206, the first operation electromagnetic wave to the interior of the heating cavity 100 in the first radiation direction based on the initial rotation speed, to heat the ingredient to be heated that is located in the first radiation direction with the first operation electromagnetic wave.

In some embodiments, radiating, by the radiator 206 in the regulation operation mode, the second operation electromagnetic wave to the plurality of heating positions in the interior of the heating cavity 100, to heat each of the plurality of intermediate state ingredients from the second temperature to the target temperature with the second operation electromagnetic wave includes: determining, by the control panel 203, the second operation electromagnetic wave based on the cooking attribute of each of the plurality of intermediate state ingredients; determining, by the control panel 203, a type of each of the plurality of intermediate state ingredients, the type including a homogenized ingredient, a non-homogenized ingredient, and a mixed ingredient; generating, by the control panel 203 based on the type, the regulation instruction corresponding to the type; regulating, by the control panel 203, an initial rotation speed based on the regulation instruction, to obtain a regulation rotation speed; radiating, by the radiator 206, the second operation electromagnetic wave to the plurality of heating positions in the interior of the heating cavity 100 based on the regulation rotation speed; and heating, based on the second operation electromagnetic wave at the plurality of heating positions, each of the plurality of intermediate state ingredients from the second temperature to the target temperature.

In some embodiments, generating, by the control panel 203 based on the type, the regulation instruction corresponding to the type includes: generating, by the control panel 203 in response to the intermediate state ingredient being the homogenized ingredient, a first regulation instruction based on the homogenized ingredient; generating, by the control panel 203 in response to the intermediate state ingredient being the non-homogenized ingredient, a second regulation instruction based on the non-homogenized ingredient; and generating, by the control panel 203 in response to the intermediate state ingredient being the mixed ingredient, a third regulation instruction based on the mixed ingredient.

In some embodiments, generating, by the control panel 203 in response to the intermediate state ingredient being the homogenized ingredient, the first regulation instruction based on the homogenized ingredient further includes: regulating, by the control panel 203, the initial rotation speed based on the first regulation instruction, to obtain a first regulation rotation speed; and radiating, by the radiator 206, the second operation electromagnetic wave to the plurality of heating positions in the interior of the heating cavity 100 based on the first regulation rotation speed.

In some embodiments, the cooking apparatus 600 is further configured to, subsequent to generating, by the control panel 203 in response to the intermediate state ingredient being the non-homogenized ingredient, the second regulation instruction based on the non-homogenized ingredient: regulate, by the control panel 203, the initial rotation speed based on the second regulation instruction, to obtain a second regulation rotation speed; and radiate, by the radiator 206, the second operation electromagnetic wave to the plurality of heating positions in the interior of the heating cavity 100 based on the second regulation rotation speed.

In some embodiments, radiating, by the radiator 206, the second operation electromagnetic wave to the plurality of heating positions in the interior of the heating cavity 100 based on the second regulation rotation speed includes: obtaining, by the control panel 203 every third predetermined period of time, fourth real-time temperatures of a plurality of points on a surface of each of the plurality of intermediate state ingredients, and drawing a fourth real-time temperature map based on the fourth real-time temperatures of the plurality of points; obtaining, by the control panel 203, a plurality of second temperature difference upper limits based on the plurality of fourth real-time temperature maps; comparing, by the control panel 203, each of the plurality of second temperature difference upper limits with a temperature difference upper limit threshold; obtaining, in response to the second temperature difference upper limit being greater than the temperature difference upper limit threshold, the fourth real-time temperatures of two points corresponding to the second temperature difference upper limit; determining a second target real-time temperature based on the fourth real-time temperatures of the two points; determining a second target point and a coordinate of the second target point based on the second target real-time temperature; determining, by the control panel 203, a second radiation direction of the radiator 206 based on the coordinate of the second target point; and radiating, by the radiator 206, the second operation electromagnetic wave to the interior of the heating cavity 100 in the second radiation direction based on the initial rotation speed, to heat the intermediate state ingredient in the second radiation direction with the second operation electromagnetic wave.

In some embodiments, the cooking apparatus 600 is further configured to, subsequent to generating, by the control panel 203 in response to the intermediate state ingredient being the mixed ingredient, the third regulation instruction based on the mixed ingredient: obtain, by the control panel 203 every fourth predetermined period of time, the heating state information on the plurality of intermediate state ingredients, the heating state information including a first state and a second state; regulate, by the control panel 203 in response to the plurality of intermediate state ingredients being in the first state, the initial rotation speed based on the third regulation instruction, to obtain a third regulation rotation speed; and radiate, by the radiator 206, the second operation electromagnetic wave to the plurality of heating positions in the interior of the heating cavity 100 based on the third regulation rotation speed.

In some embodiments, the cooking apparatus 600 is further configured to: obtain, by the control panel 203 every fifth predetermined period of time in response to the plurality of intermediate state ingredients being in the second state, fifth real-time temperatures of a plurality of points on a surface of each of the plurality of intermediate state ingredients, and draw a fifth real-time temperature map based on the fifth real-time temperatures of the plurality of points; obtain, by the control panel 203, a plurality of third temperature difference upper limits based on the plurality of fifth real-time temperature maps; compare, by the control panel 203, each of the plurality of third temperature difference upper limits with a temperature difference upper limit threshold; obtain, in response to the third temperature difference upper limit being greater than the temperature difference upper limit threshold, the fifth real-time temperatures of two points corresponding to the third temperature difference upper limit; determine a third target real-time temperature based on the fifth real-time temperatures of the two points; determine a third target point and a coordinate of the third target point based on the third target real-time temperature; determine, by the control panel 203, a third radiation direction of the radiator 206 based on the coordinate of the third target point; and radiate, by the radiator 206, the second operation electromagnetic wave to the interior of the heating cavity 100 in the third radiation direction based on the third regulation rotation speed, to heat the intermediate state ingredient that is located in the third radiation direction with the second operation electromagnetic wave.

In some embodiments, heating, based on the second operation electromagnetic wave at the plurality of heating positions, each of the plurality of intermediate state ingredients from the second temperature to the target temperature includes: heating an N-th intermediate state ingredient to an N-th target temperature at an M-th time point based on the second operation electromagnetic wave; and heating an (N+1)-th intermediate state ingredient to an (N+1)-th target temperature at an L-th time point based on the second operation electromagnetic wave, where N≥1, N is an integer, and M, L≥0.

Embodiments of the present disclosure further provide a computer-readable storage medium having a computer program stored thereon. The computer program, when executed, controls a device on which the computer-readable storage medium is located to implement the method as described above.

In addition, other components and functions of the apparatus according to the embodiments of the present disclosure are known to those skilled in the art and will be omitted herein for simplicity.

It should be noted that logic and/or steps described in other manners herein or shown in the flow chart. For example, a particular sequence table of executable instructions for implementing the logical function may be specifically implemented in any computer-readable medium to be used by an instruction execution system, apparatus, or device (such as a computer-based system, a system including a processor, or other systems capable of obtaining instructions from the instruction execution system, apparatus, or device and executing the t instructions), or to be used in combination with the instruction execution system, apparatus, or device. As to the specification, “the computer-readable medium” may be any device that may contain, store, communicate, propagate, or transfers the program to be used by the instruction execution system, apparatus, or device or may be used or in combination with the instruction execution system, apparatus, or device. More specific examples (a non-exhaustive list) of the computer-readable medium include but are not limited to: an electronic connection (an electronic device) having one or more wires, a portable computer enclosure (a magnetic device), a Random Access Memory (RAM), a Read-Only Memory (ROM), an Erasable Programmable Read-Only Memory (EPROM or a flash memory), an optical fiber device, and a portable Compact Disk Read-Only Memory (CDROM). In addition, the computer-readable medium may even be a paper or other appropriate medium capable of printing programs thereon. These paper or other appropriate medium may be optically scanned and then edited, decrypted, or processed with other appropriate manners as desired to obtain the programs in an electric manner, and then the programs may be stored in the computer memory.

It should be understood that each part of the present disclosure may be realized by hardware, software, firmware, or a combination thereof. In the above embodiments, a plurality of steps or methods may be implemented by the software or firmware stored in the memory and executed by the appropriate instruction execution system. For example, when implemented by the hardware, likewise in another embodiment, the steps or methods may be implemented by one or a combination of the following techniques known in the art: a discrete logic circuit having a logic gate circuit for realizing a logic function of a data signal, an application-specific integrated circuit having an appropriate combination logic gate circuit, a Programmable Gate Array (PGA), a Field Programmable Gate Array (FPGA), etc.

In the description of this specification, descriptions with reference to the terms “an embodiment”, “some embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials, or characteristics may be combined in any one or more embodiments or examples in a suitable manner.

In the description of the present disclosure, it should be understood that the orientation or position relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” etc., is based on the orientation or position relationship shown in the drawings, and is only for the convenience of describing the present disclosure and simplifying the description, rather than indicating or implying that the associated device or element must have a specific orientation, or be constructed and operated in a specific orientation, and therefore cannot be understood as a limitation on the present disclosure.

In addition, the terms “first” and “second” are merely used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, such as two, three, etc., unless otherwise specifically defined.

In the present disclosure, unless otherwise clearly specified and limited, terms such as “installed”, “connected”, “coupled”, “fixed”, and the like should be understood in a broad sense. For example, it may be a fixed connection or a detachable connection or integral connection; a mechanical connection or an electrical connection; a direct connection or an indirect connection through an intermediate; internal communication of two components or an interaction relationship between two components, unless otherwise clearly limited. For those of ordinary skill in the art, the specific meaning of the above-mentioned terms in the present disclosure can be understood according to specific circumstances.

In the present disclosure, unless expressly stipulated and defined otherwise, the first feature being “on” or “under” the second feature may mean that the first feature is in direct contact with the second feature or in indirect contact through an intermediate. Moreover, the first feature being “above” and “over” the second feature may mean that the first feature is directly above or obliquely above the second feature, or simply mean that the level of the first feature is higher than that of the second feature. The first feature being “below” the second feature may mean that the first feature is directly below or obliquely below the second feature, or simply mean that the level of the first feature is smaller than that of the second feature.

Although the embodiments of the present disclosure have been shown and described above, it should be understood that the above-mentioned embodiments are exemplary and should not be construed as limiting the present disclosure. Those of ordinary skill in the art can make changes, modifications, substitutions, and modifications to the above-mentioned embodiments within the scope of the present disclosure.

What is claimed is:

1. A cooking method, comprising:
obtaining, by a control panel, state information on a plurality of ingredients to be heated, and generating a control instruction based on the state information, wherein the state information comprises a first temperature and a cooking attribute of each of the plurality of ingredients to be heated;
controlling, by the control panel based on the control instruction, a radiator to radiate, in an initial operation mode, a first operation electromagnetic wave to a plurality of heating positions in an interior of a heating cavity, to heat each of the plurality of ingredients to be heated from the first temperature to a second temperature with the first operation electromagnetic wave to obtain a plurality of intermediate state ingredients, wherein a parameter of the initial operation mode comprises a rotation speed and a radiation direction of the radiator;
generating, by the control panel, a plurality of regulation instructions based on heating state information on the plurality of intermediate state ingredients;
adjusting, by the control panel, the first operation electromagnetic wave based on the plurality of regulation instructions, to obtain a second operation electromagnetic wave;
adjusting, by the control panel, the initial operation mode based on the plurality of regulation instructions, to obtain a regulation operation mode; and
radiating, by the radiator in the regulation operation mode, the second operation electromagnetic wave to the plurality of heating positions in the interior of the heating cavity, to heat each of the plurality of intermediate state ingredients from the second temperature to a target temperature with the second operation electromagnetic wave.

2. The method according to claim 1, further comprising, prior to said controlling, by the control panel based on the control instruction, the radiator to radiate, in the initial operation mode, the first operation electromagnetic wave to the plurality of heating positions in the interior of the heating cavity:
obtaining, by the control panel, first real-time temperatures of a plurality of points on a surface of each of the plurality of ingredients to be heated, and drawing, by the control panel, a first real-time temperature map based on the first real-time temperatures of the plurality of points;
obtaining, by the control panel based on the first real-time temperature map, the first temperature of each of the plurality of ingredients to be heated, and comparing the first temperature with a defrosting temperature;
determining, in response to the first temperature being smaller than the defrosting temperature, one of the plurality of ingredients to be heated corresponding to the first temperature as an ingredient to be defrosted, and determining, based on the first real-time temperature map, a coordinate of the ingredient to be defrosted;
generating, by the control panel, a defrosting instruction based on the ingredient to be defrosted and the coordinate of the ingredient to be defrosted;
adjusting, by the control panel, the first operation electromagnetic wave based on the defrosting instruction to obtain a defrosting operation electromagnetic wave; and
radiating, by the radiator based on the initial operation mode, the defrosting operation electromagnetic wave to the ingredient to be defrosted, and heating the ingredient to be defrosted to a first predetermined temperature.

3. The method according to claim 1, further comprising, prior to said controlling, by the control panel based on the control instruction, the radiator to radiate, in the initial operation mode, the first operation electromagnetic wave to the plurality of heating positions in the interior of the heating cavity:
obtaining, by the control panel every first predetermined period of time, second real-time temperatures of a plurality of points on a surface of each of the plurality of ingredients to be heated, and drawing a second real-time temperature map based on the second real-time temperatures of the plurality of points;
obtaining, by the control panel, temperature rise rates of the plurality of points based on the second real-time temperature map;
determining a target temperature rise rate based on the temperature rise rates of the plurality of points; and
determining an initial rotation speed of the radiator based on the target temperature rise rate.

4. The method according to claim 3, wherein said controlling, by the control panel based on the control instruction, the radiator to radiate, in the initial operation mode, the first operation electromagnetic wave to the plurality of heating positions in the interior of the heating cavity comprises:
determining, by the control panel, the first operation electromagnetic wave based on the cooking attribute of each of the plurality of ingredients to be heated;
obtaining, by the control panel every second predetermined period of time, third real-time temperatures of the plurality of points on the surface of each of the plurality of ingredients to be heated, and drawing a third real-time temperature map based on the third real-time temperatures of the plurality of points;
obtaining, by the control panel, a plurality of first temperature difference upper limits based on a plurality of third real-time temperature maps;
comparing, by the control panel, each of the plurality of first temperature difference upper limits with a temperature difference upper limit threshold;
obtaining, in response to the first temperature difference upper limit being greater than the temperature difference upper limit threshold, the third real-time temperatures of two points corresponding to the first temperature difference upper limit;
determining a first target real-time temperature based on the third real-time temperatures of the two points;
determining a first target point and a coordinate of the first target point based on the first target real-time temperature;
determining, by the control panel, a first radiation direction of the radiator based on the coordinate of the first target point; and
radiating, by the radiator, the first operation electromagnetic wave to the interior of the heating cavity in the first radiation direction based on the initial rotation speed, to heat the ingredient to be heated that is located in the first radiation direction with the first operation electromagnetic wave.

5. The method according to claim 1, wherein said radiating, by the radiator in the regulation operation mode, the second operation electromagnetic wave to the plurality of heating positions in the interior of the heating cavity, to heat each of the plurality of intermediate state ingredients from the second temperature to the target temperature with the second operation electromagnetic wave comprises:
determining, by the control panel, the second operation electromagnetic wave based on the cooking attribute of each of the plurality of intermediate state ingredients;
determining, by the control panel, a type of each of the plurality of intermediate state ingredients, wherein the type comprises a homogenized ingredient, a non-homogenized ingredient, and a mixed ingredient;
generating, by the control panel based on the type, the regulation instruction corresponding to the type;
regulating, by the control panel, an initial rotation speed based on the regulation instruction, to obtain a regulation rotation speed;
radiating, by the radiator, the second operation electromagnetic wave to the plurality of heating positions in the interior of the heating cavity based on the regulation rotation speed; and
heating, based on the second operation electromagnetic wave at the plurality of heating positions, each of the plurality of intermediate state ingredients from the second temperature to the target temperature.

6. The method according to claim 5, wherein said generating, by the control panel based on the type, the regulation instruction corresponding to the type comprises:
generating, by the control panel in response to the intermediate state ingredient being the homogenized ingredient, a first regulation instruction based on the homogenized ingredient;
generating, by the control panel in response to the intermediate state ingredient being the non-homogenized ingredient, a second regulation instruction based on the non-homogenized ingredient; and
generating, by the control panel in response to the intermediate state ingredient being the mixed ingredient, a third regulation instruction based on the mixed ingredient.

7. The method according to claim 6, wherein said generating, by the control panel in response to the intermediate state ingredient being the homogenized ingredient, the first regulation instruction based on the homogenized ingredient comprises:
regulating, by the control panel, the initial rotation speed based on the first regulation instruction, to obtain a first regulation rotation speed; and
radiating, by the radiator, the second operation electromagnetic wave to the plurality of heating positions in the interior of the heating cavity based on the first regulation rotation speed.

8. The method according to claim 6, further comprising, subsequent to said generating, by the control panel in response to the intermediate state ingredient being the non-homogenized ingredient, the second regulation instruction based on the non-homogenized ingredient:
regulating, by the control panel, the initial rotation speed based on the second regulation instruction, to obtain a second regulation rotation speed; and
radiating, by the radiator, the second operation electromagnetic wave to the plurality of heating positions in the interior of the heating cavity based on the second regulation rotation speed.

9. The method according to claim 8, wherein said radiating, by the radiator, the second operation electromagnetic wave to the plurality of heating positions in the interior of the heating cavity based on the second regulation rotation speed comprises:
obtaining, by the control panel every third predetermined period of time, fourth real-time temperatures of a plurality of points on a surface of each of the plurality of intermediate state ingredients, and drawing a fourth real-time temperature map based on the fourth real-time temperatures of the plurality of points;
obtaining, by the control panel, a plurality of second temperature difference upper limits based on a plurality of fourth real-time temperature maps;
comparing, by the control panel, each of the plurality of second temperature difference upper limits with a temperature difference upper limit threshold;
obtaining, in response to the second temperature difference upper limit being greater than the temperature difference upper limit threshold, the fourth real-time temperatures of two points corresponding to the second temperature difference upper limit;
determining a second target real-time temperature based on the fourth real-time temperatures of the two points;
determining a second target point and a coordinate of the second target point based on the second target real-time temperature;
determining, by the control panel, a second radiation direction of the radiator based on the coordinate of the second target point; and
radiating, by the radiator, the second operation electromagnetic wave to the interior of the heating cavity in the second radiation direction based on the initial rotation speed, to heat the intermediate state ingredient located in the second radiation direction with the second operation electromagnetic wave.

10. The method according to claim 6, further comprising, subsequent to said generating, by the control panel in response to the intermediate state ingredient being the mixed ingredient, the third regulation instruction based on the mixed ingredient:
obtaining, by the control panel every fourth predetermined period of time, the heating state information on the plurality of intermediate state ingredients, wherein the heating state information comprises a first state and a second state;
regulating, by the control panel in response to the plurality of intermediate state ingredients being in the first state, the initial rotation speed based on the third regulation instruction, to obtain a third regulation rotation speed; and
radiating, by the radiator, the second operation electromagnetic wave to the plurality of heating positions in the interior of the heating cavity based on the third regulation rotation speed.

11. The method according to claim 10, further comprising:
obtaining, by the control panel every fifth predetermined period of time in response to the plurality of intermediate state ingredients being in the second state, fifth real-time temperatures of a plurality of points on a surface of each of the plurality of intermediate state ingredients, and drawing a fifth real-time temperature map based on the fifth real-time temperatures of the plurality of points;
obtaining, by the control panel, a plurality of third temperature difference upper limits based on a plurality of fifth real-time temperature maps;
comparing, by the control panel, each of the plurality of third temperature difference upper limits with a temperature difference upper limit threshold;
obtaining, in response to the third temperature difference upper limit being greater than the temperature difference upper limit threshold, the fifth real-time temperatures of two points corresponding to the third temperature difference upper limit;
determining a third target real-time temperature based on the fifth real-time temperatures of the two points;
determining a third target point and a coordinate of the third target point based on the third target real-time temperature;
determining, by the control panel, a third radiation direction of the radiator based on the coordinate of the third target point; and
radiating, by the radiator, the second operation electromagnetic wave to the interior of the heating cavity in the third radiation direction based on the third regulation rotation speed, to heat the intermediate state ingredient located in the third radiation direction with the second operation electromagnetic wave.

12. The method according to claim 5, wherein said heating, based on the second operation electromagnetic wave at the plurality of heating positions, each of the plurality of intermediate state ingredients from the second temperature to the target temperature comprises:
heating an N-th intermediate state ingredient to an N-th target temperature at an M-th time point based on the second operation electromagnetic wave; and
heating an (N+1)-th intermediate state ingredient to an (N+1)-th target temperature at an L-th time point based on the second operation electromagnetic wave,
where N≥1, N is an integer, and M, L≥0.

13. A cooking apparatus, comprising:
an obtaining module configured to obtain, by a control panel, state information on a plurality of ingredients to be heated, and generate a control instruction based on the state information, wherein the state information comprises a first temperature and a cooking attribute of each of the plurality of ingredients to be heated;
a first heating module configured to control, by the control panel based on the control instruction, a radiator to radiate, in an initial operation mode, a first operation electromagnetic wave to a plurality of heating positions in an interior of a heating cavity, to heat the plurality of ingredients to be heated from the first temperature to a second temperature with the first operation electromagnetic wave to obtain a plurality of intermediate state ingredients, wherein a parameter of the initial operation mode comprises a rotation speed and a radiation direction of the radiator;
a generation module configured to generate, by the control panel, a plurality of regulation instructions based on heating state information on the plurality of intermediate state ingredients;
a regulation module configured to: adjust, by the control panel, the first operation electromagnetic wave based on the plurality of regulation instructions to obtain a second operation electromagnetic wave, to adjust, by the control panel, the initial operation mode based on the plurality of regulation instructions to obtain a regulation operation mode; and
a second heating module configured to radiate, by the radiator in the regulation operation mode, the second operation electromagnetic wave to the plurality of heating positions in the interior of the heating cavity, to heat each of the plurality of intermediate state ingredients from the second temperature to a target temperature with the second operation electromagnetic wave.

14. A cooking device, comprising:
a heating cavity configured to accommodate a plurality of ingredients to be heated;
an energy supply structure connected to the heating cavity and comprising:
a control panel configured to: obtain state information on the plurality of ingredients to be heated, and generate a control instruction based on the plurality of ingredients to be heated, the state information comprising a first temperature and a cooking attribute of each of the plurality of ingredients to be heated;
a magnetron in a communication connection with the control panel, the magnetron being configured to obtain an operation power based on the control instruction, and transmit an operation electromagnetic wave to an interior of the heating cavity based on the operation power; and
a radiator in a communication connection with the control panel, the radiator being configured to: determine a rotation speed and a radiation direction based on the control instruction, and radiate the operation electromagnetic wave to a plurality of heating positions in the interior of the heating cavity based on the rotation speed and the radiation direction, the operation electromagnetic wave at the plurality of heating positions being capable of heating each of the plurality of ingredients to be heated to a target temperature.

15. The device according to claim 14, further comprising a variable frequency plate in a communication connection with the control panel, wherein:
the energy supply structure is disposed on the variable frequency plate, and
the variable frequency plate is configured to adjust the operation power based on the control instruction.

16. The device according to claim 15, wherein:
the radiator is connected to a stepper motor in a communication connection with the control panel; and
the control panel is configured to adjust the rotation speed of the radiator by controlling the stepper motor.

17. The device according to claim 16, wherein:
the energy supply structure further comprises a scanning unit in a communication connection with the control panel; and
the scanning unit is configured to scan each of the plurality of ingredients to be heated to obtain the cooking attribute of each of the plurality of ingredients, and transmit the cooking attribute to the control panel.

18. The device according to claim 17, wherein a state monitoring unit is provided in the interior of the heating cavity and in a communication connection with the control panel, the state monitoring unit being configured to monitor a real-time state of the plurality of ingredients to be heated in a heating state, and transmit monitored real-time state information to the control panel.

19. The device according to claim 14, wherein a temperature monitoring unit is provided in the interior of the heating cavity and in a communication connection with the control panel, the temperature monitoring unit being configured to collect temperatures of the plurality of ingredients to be heated and transmit collected temperature information to the control panel.

20. A non-transitory computer-readable storage medium, having a computer program stored thereon, wherein the computer program, when executed, controls a device on which the computer-readable storage medium is located, to implement the method according to claim 1.
